(19) United States
(12) Patent Application Publication
(10) Pub. No.: US 2005/0273609 A1
(43) Pub. Date: Dec. 8, 2005

(54) Setting up a short-range wireless data transmission connection between devices

(75) Inventor: Pasi Eronen, Helsinki (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/861,318

(22) Filed: Jun. 4, 2004

(51) Int. Cl. H04L 9/00

(52) U.S. Cl. 713/171

(57) ABSTRACT

The invention relates to a method for setting up a short-range wireless data transmission connection between a first and a second device. The method comprises conducting a set up stage to transmit set up information from the first device to the second device, and using said set up information in the second device to set up the connection between the first device and the second device. The set up stage comprises forming an acoustical signal including said set up information and transmitting said acoustical signal from the first device to the second device. The invention also relates to a communication system, a device, a module and a computer program product in which the method will be applied.

### FIELD OF THE INVENTION

The present invention relates to a method for setting up a short-range wireless data transmission connection between a first and a second device, the method comprising conducting a set up stage to transmit set up information from the first device to the second device, and using the set up information in the second device to set up the connection between the first device and the second device. The invention also relates to a communication system comprising at least a first and a second device, and means for setting up a short-range wireless radio communication between the first and second device. Moreover, the invention relates to a device comprising at least short-range wireless radio communication means for performing short-range data transmission with another device, and an acoustical transmitter for transmitting acoustical signals comprising set up information from the first device to the another device. The invention also relates to a module and a computer program product.

### BACKGROUND OF THE INVENTION

In this specification the concept of short-range radio data transmission connection refers primarily to such connections in which two or more devices that are located relatively close to each other can communicate with each other in a wireless manner using radio signals. For example the Bluetooth™ technology, in which low-power radio transmitters and radio receivers are used, has been developed for the purpose of short-range radio communication. Such devices can communicate with each other and thereby form an ad hoc communication system. By applying short-range communication technology it is for example possible to connect peripheral devices to a computer in a wireless manner. Furthermore, for example a wireless communication device can be coupled to a portable computer, wherein from the computer it is possible to have a wireless connection to another communication network, such as the Internet data network. Thus, a situation may occur in which the user has to enter his/her user identification and password when he/she is setting up a connection to a data network by means of the portable computer. Thus, there is a risk that it is possible to eavesdrop the user identification and password transmitted without encryption between the portable computer and a wireless communication device connected thereto with a short-range radio data transmission connection.

Other possible implementation areas for short-range radio data transmission connections that can be mentioned in this context include wireless local area network (WLAN), wireless pay terminal system and wirelessly operating lock. By means of a wireless local area network it is for example in small office facilities possible to implement a local area network comprising several computers without having to conduct cabling. In a wireless pay terminal system the user can pay bills for example by means of a wireless communication device which also contains short-range communication means. Thus, a short-range data transmission connection is set up between the wireless communication device and the pay terminal for the purpose of paying bills. Correspondingly, in a wirelessly operating lock the user has a key that communicates wirelessly with the lock to ensure that the key in question is intended for controlling the function of this particular lock. Such a key may be implemented as a separate key, or it may be implemented in connection with another device, such as a wireless communication device.

In such communication systems it is problematic how the different parties in the communication can be sure that the devices in question are really authorized to the communication process. This is important especially in such situations where confidential information is transferred between different devices. For example, in the aforementioned pay terminal embodiment the pay terminal has to ensure that the device used in the payment transaction really is the device used by the account holder in question or a person authorized by the account holder. Also in the lock embodiment the lock has to ensure the authenticity of the key before the lock is opened. In such embodiments, for the purpose of verifying the parties, the communication between the devices has to be protected as well as possible from outside intruders, such as eavesdroppers and intervening parties. To take these safety aspects into account, different encryption mechanisms have been developed e.g. for said Bluetooth™ systems. The techniques that are used include e.g. a key pair (PKI, Public Key Infrastructure) composed of a public key and a private key. In such an arrangement the user has a public key that he/she can send to a counterparty without encryption, and a private key which does not have to be transferred to the communication system at any stage, but the user has to keep it concealed. Thus, it is possible to transmit encrypted information to the user by encrypting the information with said public key. The user can decrypt the information with his/her private key.

Currently Bluetooth™ pairing (forming a connection between two Bluetooth™ devices) works roughly as follows: The user uses one of the devices (which has to have a keyboard and display) to activate the pairing. This device displays a list of all devices that are nearby, and the user chooses the intended device from the list. The user then selects a secret PIN code and enters it to the device. The device then contacts the other device(s), and once the user has entered the same PIN code to the other device(s), the devices establish a link key that is stored for further use.

Devices that do not have keyboards (such as headsets) usually have a fixed PIN code that comes on a piece of paper with the device. Some manufacturers even use the same PIN code (usually “0000”) for all devices shipped.

The problem is that the current approach is both difficult to use for the user, and insecure. Even if the PIN code is chosen by the user, it is usually too short and easily guessable, since entering long random numbers is cumbersome.

Communication systems also apply symmetric encryption methods in which both parties of the communication share the same private key (shared key, shared secret). A problem in this arrangement is, for example, how this private key can be transmitted to another device so that an outsider cannot find out the private key. In some cases the user himself/herself can enter this private key to different devices. In a device according to the Bluetooth™ system this private key is utilized to calculate a link key used in the radio communication, by means of which link key the actual information to be transmitted is encrypted. The maximum length determined for the link key is 128 bits, wherein the length of the private key should be at least 32 characters. It is laborious to enter such a string containing 32 characters, and there is high probability of errors, especially when the string has to be entered successively at least twice without errors before the connection can be set up.

The patent U.S. Pat. No. 5,241,599 discloses a method for encrypted key exchange (EKE), in which the encryption key used in the communication is first encrypted with a short encryption key, whereafter the encryption key can be transmitted in the encrypted format from one device to another via an unencrypted communication channel. In short-range systems this method can be applied in such a manner that the user enters said short encryption key to both devices, whereafter both devices transmit the encryption key of their own to the other device, encrypted with a short encryption key. Such systems have, for example, the drawback that the encryption efficiency is dependent for example on how often the user changes this short encryption key. Furthermore, such a short encryption key selected by the user can be guessed relatively easily, and therefore when the method is applied, it is possible that outsiders find out the short encryption key.

There is a so-called Diffie-Hellman method, which is based on exponentiation modulo of a large prime number. On the basis of this, the difficulty in breaking encryption implemented with the Diffie-Hellman method is today regarded directly proportional to the difficulty of calculating discrete logarithms modulo of a large prime number. The Diffie-Hellman method is a public key based algorithm generally used especially in key exchange. The method is considered safe when keys of sufficient length and an appropriate Diffie-Hellman generator are used. In the Diffie-Hellman method the first party determines a first key number on the basis of a first secret number and the first key number is transmitted to the second party. Correspondingly, the second party determines a second key number on the basis of a second secret number and the second key number is transmitted to the first party. Thereafter, the first party generates a third key number on the basis of the first secret number and the second key number it has received, and the second party generates a fourth key number on the basis of the second secret number and the first key number it has received. The third and the fourth key numbers are identical, and they are not transmitted between the parties involved. The third and the fourth key number can thereafter be used for encryption and decryption of information to be transmitted between the parties. In this arrangement it is, however, possible that a third party is capable of changing the first key number or the second key number. This takes place for example in such a manner that a third party places itself between the first and the second party (MIM, Man In the Middle), wherein the first party mistakes the third party for the second party, and, in a corresponding manner, the second party mistakes the third party for the first party. Thus, in practise, data is transmitted between the first and the second party via the third party, and the third party detects both messages transmitted by the first party and messages transmitted by the second party, and is capable of modifying them. The Diffie-Hellman method is described in more detail in the U.S. Pat. No. 4,200,770 to which reference is made in this context.

An improvement has been suggested for the Diffie-Hellman method, by means of which different parties in a short-range wireless communication method can be verified. The method is disclosed in the publication F. Stajano, R. Anderson, The Resurrecting Duckling: Security Issues for Ad-Hoc Wireless Networks, 1999 AT&T Software Symposium. The method disclosed in this publication is based on the fact that both parties check that the third and the fourth encryption numbers obtained as a result of the actions described above are identical. This can be conducted for example in such a manner that the calculated encryption numbers are displayed in the devices of both parties and the users of the devices compare these numbers with each other. However, to attain a sufficiently strong encryption (an encryption key of at least 128 bits) the encryption numbers have to be strings composed of at least 32 characters. It is difficult to compare such strings which are relatively long, and the error probability is high.

It is also possible to store the PIN code in an RFID tag attached to the device. The code is read with an RFID reader attached to the other device. This way, the PIN code can be different for each device, and can be sufficiently long to prevent guessing attacks. However, this arrangement needs an RFID reader in the other device. It is also possible that the PIN code can be eavesdropped by a radio receiver.

### SUMMARY OF THE INVENTION

It is an aim of the present invention to provide an improved method to set up a short-range wireless data transmission connection between devices, a communication system and a device. The invention is based on the idea that at least some information needed in the set up is transmitted from a first device to a second device via an acoustic communication method by using acoustic signals. The second device receives the information and uses it in the set up process.

In an example embodiment the information relates to delivering address information of the first device to the second device. The first device transmits address information, for example a Bluetooth™ address, of the first device to the second device via the acoustic communication method. The second device receives the address information and uses it in short range radio communication with the first device. Therefore, there is no need to conduct address query communication by the second device to find out the address of the first device.

In another example embodiment the information relates to ensuring data transmission security, wherein a key is transmitted from the first device to the second device via the acoustic communication method. The second device receives the key and informs the first device that the second device has received the key. This may be performed, for example, so that the second device calculates a second key on the basis of the received key and a first algorithm, forms a reply message which may include the calculated second key, encrypts the message and transmits the encrypted message to the first device. The first device receives the encrypted message and decrypts it. For the decryption process the first device calculates the second key on the basis of the key and the first algorithm after which the second key can be used in the first device to decrypt the encrypted message.

In yet another example embodiment of the present invention it is also possible to perform a checking stage for increasing the trustworthiness of the key exchange stage. In the checking stage a check code is calculated in both devices on the basis of the key or another value. The calculated check code is transmitted either from one device to the other device or both devices exchange the calculated check codes. The codes can be compared with each other in the device which has received the check code from the other device, or in the case the check codes are exchanged both devices can perform the comparison before starting the short-range communication via a radio path.

According to a first aspect of the present invention there is provided a method for setting up a short-range wireless data transmission connection between a first and a second device, the method comprising conducting a set up stage to transmit set up information from the first device to the second device, and using said set up information in the second device to set up the connection between the first device and the second device, the set up stage comprising forming an acoustical signal including said set up information and transmitting said acoustical signal from the first device to the second device.

According to a second aspect of the present invention there is provided a communication system comprising at least a first and a second device, means for setting up a short-range wireless radio communication between said first and second device;
the first device comprising at least an acoustical transmitter for transmitting acoustical signals comprising set up information from the first device to the second device; the second device comprising at least:
   an acoustical receiver for receiving acoustical signals comprising said set up information from the first device; and
   means for using said set up information in the second device to set up the connection between the first device and the second device.

According to a third aspect of the present invention there is provided a device comprising at least short-range wireless radio communication means for performing short-range data transmission with another device, and an acoustical transmitter for transmitting acoustical signals comprising set up information from the first device to the another device.

According to a fourth aspect of the present invention there is provided a module to be used in connection with a device comprising at least short-range wireless radio communication means for performing short-range data transmission with another device, the module comprising an acoustical transmitter for transmitting acoustical signals comprising set up information from the first device to the another device.

According to a fifth aspect of the present invention there is provided a computer program product comprising machine executable steps for setting up a short-range wireless data transmission connection between a first and a second device, steps for conducting a set up stage to transmit set up information from the first device to the second device, and steps for using said set up information in the second device to set up the connection between the first device and the second device, the set up stage comprising machine executable steps for forming an acoustical signal including said set up information and transmitting said acoustical signal from the first device to the second device.

The present invention shows advantages compared to solutions of prior art. When the method according to the invention is applied, it is possible to delivery long keys between devices without the need to manually enter the keys to the devices. Because the keys are delivered via a short distance non-radio communication the user(s) of the devices can be almost sure that there is negligible risk for the key being delivered to an unauthorised device. It is not necessary for the user himself/herself to enter any identification numbers in the beginning of a connection set-up, but the set-up of a connection is started normally by selecting for example a second device from a menu which is formed in the device for this purpose. Further, there is no need to conduct address query communication by the second device to find out the address of the first device. Since one-time check strings can be used in the method according to the invention, it is not easy to guess the check strings and, on the other hand, because the same check string is not necessarily used the next time authentication is performed, outsiders will not have any use for the check strings detected afterwards. Thus, a better security of the communication system can be obtained than when solutions of prior art are used.

### DESCRIPTION OF THE DRAWINGS

In the following, the invention will be described in more detail with reference to the appended drawings, in which:

FIG. 1 shows the method according to a first embodiment of the invention in a reduced manner,

FIG. 2 shows a method according to a second embodiment of the invention in a reduced manner,

FIG. 3 shows the method according to a third embodiment of the invention in a reduced manner, and

FIG. 4 shows a communication system according to a first embodiment of the invention as a reduced block diagram.

### DETAILED DESCRIPTION OF THE INVENTION

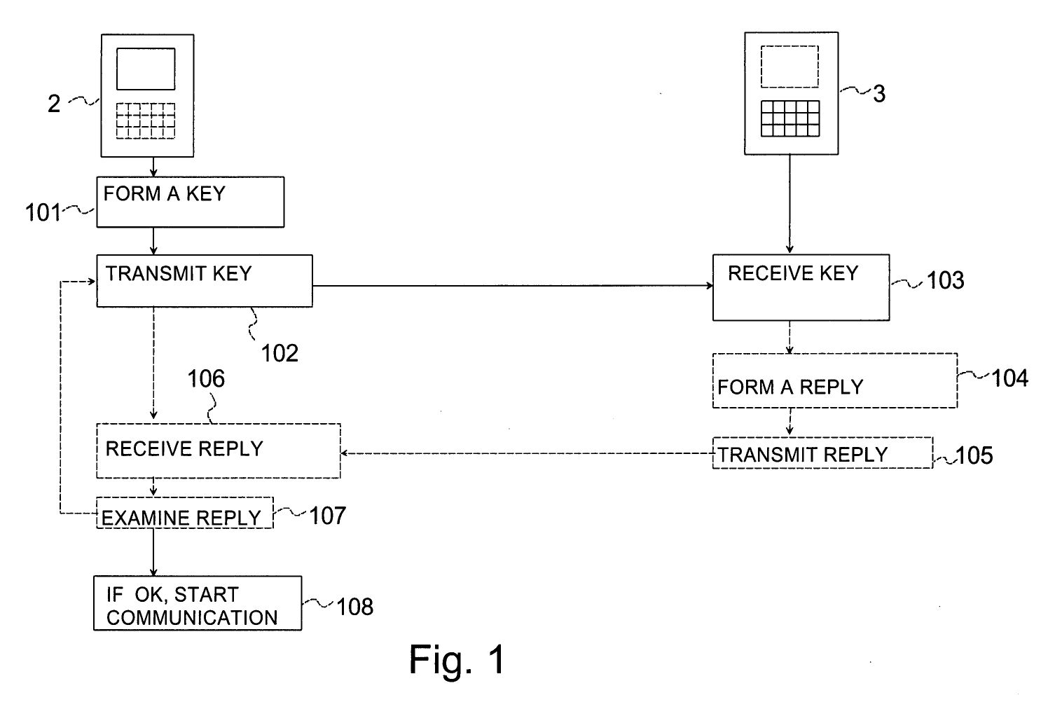

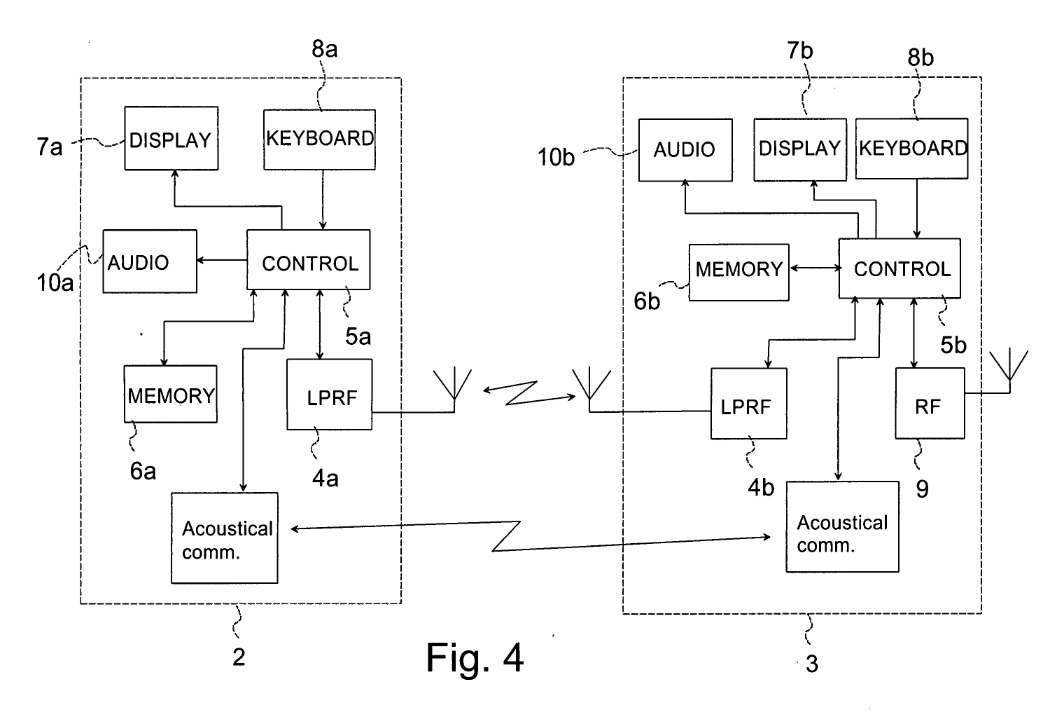

In the following, the operation of the method according to a first embodiment of the invention will be described in more detail with reference to the reduced flow diagram shown in FIG. 1 and using the communication system according to FIG. 4 as an example. The communication system comprises a first device 2 and a second device 3. The first device 2 is for example a portable computer (Laptop PC), a printer, a headset, a PDA device, etc. The second device 3 is for example a wireless device, such as a mobile phone, a wireless communication device, etc. It is, however, obvious that these devices 2, 3 are only non-restrictive example embodiments, and the devices 2, 3 used in connection with the invention can also differ from those presented herein. The first 2 and the second device 3 comprise first communication means 4a, 4b, such as a low power radio receiver (LPRF, Low Power RF), and second communication means 11a, 11b. The first communication means 4a, 4b are short-range radio communication means and the second communication means 11a, 11b are short-range acoustic communication means such as an acoustic transmitter and receiver. By means of the first communication means 4a, 4b the devices can communicate with each other wirelessly via radio waves. Furthermore, the devices 2, 3 contain a control block 5a, 5b that advantageously comprises a microprocessor or the like, and a memory 6a, 6b. The first device 2, the second device 3 or both can comprise a display 7a, 7b for presenting information and/or input means 8a, 8b for inputting information. The input means 8a, 8b comprise, for example, a keyboard, but it is obvious that other kinds of input means, such as data input means based on audio control can be applied in this context. The devices 2, 3 may also comprise audio means 10a, 10b, such as an earpiece/a speaker and/or a microphone. In the system according to FIG. 4, the second device 3 also comprises mobile station functions, which are illustrated by block 9. It is obvious that the display 7a, 7b and/or the input means 8a, 8b are not necessarily needed in both devices 2, 3.

It should be noted here that the second communication means 11a, 11b of the devices 2, 3 are not necessarily needed but the audio means 10a, 10b of the devices 2, 3 can also be used in some implementations as the second communication means 11a, 11b. The advantage of using the audio means 10a, 10b of the devices 2, 3 as the second communication means 11a, 11b is that no additional means are needed to implement the invention.

In a situation where the aim is to set up a data transmission connection between the first 2 and the second device 3, the following steps are taken in the method according to the first embodiment of the invention. The devices 2, 3 aim at detecting whether there are other possible devices in the vicinity to which a data transmission connection can be set up. In this context this stage is called a paging stage, and it can be implemented for example in the following manner. At least one device 2, 3 transmits paging messages or the like at intervals, and listens to possible reply messages by means of a receiver of the communication means 4. Thus, in a situation where either of the devices 2, 3 transmits a paging message, the device 2, 3 that has received the paging message transmits a reply message to the device 2, 3 that has transmitted the paging message. The paging message may contain the address information of the device which transmits the paging message. In an example embodiment of the present invention the paging message is transmitted using the second communication means 11a, 11b but it is also possible to use the short range radio communication in the paging. The user of the device can be presented with a list of other devices that are possibly detected in the vicinity. Thus, the user can select one or more devices from this list, and a data transmission connection is set up thereto. When the method according to the invention is applied in setting up a data transmission connection, it is not, however, necessary for the user to enter an identification number or the like. In connection with the paging stage the devices 2, 3 can transmit the address of their own to the other party involved in the data transmission connection to be set up, wherein these addresses individualizing the device 2, 3 are used in the communication thereafter. After the paging stage both devices 2, 3 may perform an interactive key exchange stage to generate the same secret key K in both devices. According to the first embodiment of the present invention the interactive key exchange stage comprises the following steps. First, in the first device 2 a key is defined (block 101 in FIG. 1) by, for example, randomly selecting a set of characters (numbers, letters, etc.) or reading an identifier from the memory 6a of the first device 2. The identifier can be unique for each device wherein different devices produce different keys. The first device 2 stores the key into the memory 6a when necessary, for example when the key is randomly generated. The first device 2 also forms a message comprising at least the key and transmits (block 102) the message by the second communication means 11a to the second device 3. The second communication means 11b of the second device 3 receives (block 103) the message and determines the contents of the message i.e. the key. The key is stored into the memory 6b of the second device 3.

It should be noted here that the key exchange process is not necessarily performed by the devices according to the present invention but only the set up procedure is conducted by using the acoustic signalling. It is also possible that the set up procedure is performed by the short range radio communication and the key exchange procedure is performed by using the acoustic signalling.

After the second device 3 has received the key it can reply to the first device 2 that the key is received. For that purpose the second device 3 forms (block 104) a reply message including information relating to the key in an encrypted form, or the message may only comprise an acknowledgment of the receiving of the key. If the reply message is included with information relating to the key the information is encrypted in this embodiment of the present invention. The encryption is performed by using an encryption algorithm having the key as a parameter. The second device 3 calculates the encryption algorithm and includes the result of the calculation into the reply message. The reply message is then transmitted (block 105) from the second device 3 to the first device 2 by the first communication means 4b. The first communication means 4a of the first device 2 receive (block 106) the reply message and decrypt, when necessary, the information of the reply message. If the reply message comprises information relating to the key, the first device 2 can compare the key it has transmitted with the key it has received to find out if they are identical or not. If the reply message only indicates the success or failure of receiving the key by the second device 3, the first device 2 examines (block 107) this indication to determine whether the communication can be started (block 108) or whether the key needs to be transmitted again.

If the first device 2 determines while examining the reply message that the key was properly received by the second device 3, the key can be used as an encryption key in the short-range communication between the first 2 and the second device 3. Otherwise the first device 2 may try to resend the key to the second device 3 or inform the user of the first device 2 that the delivery of the key was unsuccessful.

Although in the example presented above it was described that the reply message was transmitted by using the first communication means 4a, 4b it is also possible to transmit the reply message by using the second communication means 11a, 11b. In that case the reply message may include the key in unencrypted form because the risk that the key is eavesdropped is very small. It is also possible that no reply messages are transmitted after the delivery of the key wherein the short-range communication can be started after the second device 3 has received the key. However, there may be a need for a short delay in the first device 2 before starting the short-range communication so that the second device 3 has enough time for receiving and decoding the message including the key.

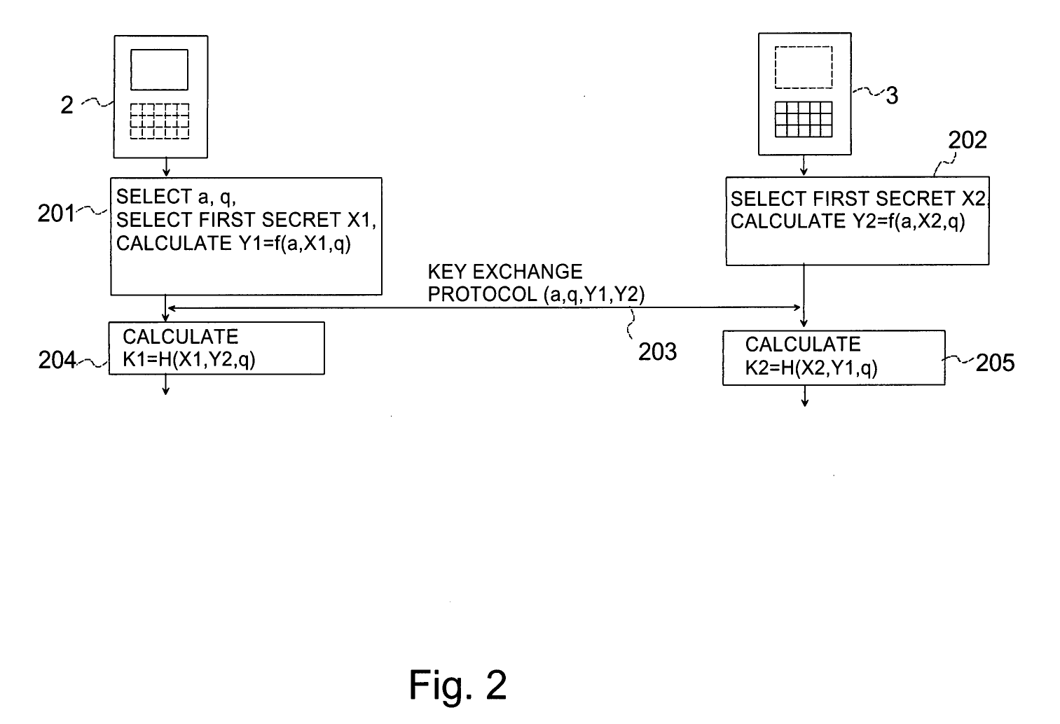

In a second embodiment of the present invention there is provided an extended key exchange stage. The key exchange stage is conducted (arrow 203 in FIG. 2) using for example the Diffie-Hellman key exchange protocol. Thus, in the first device 2 parameters a, q are selected, a first secret X1 is generated, and a first key Y1 is calculated, for example by means of the formula Y1=a^{x1} mod q (block 201). The first device 2 transmits the values a, q, Y1 to the second device 3 by the second communication means 11a. The values a, q, Y1 are received by the second communication means 11b of the second device 3. The second device 3 generates (block 202) a second secret X2, calculates a second key Y2 by means of the formula Y2=a^{X2} mod q and transmits the second key Y2 to the first device 2 by the second communication means 11b. The second key Y2 is received by the second communication means 11a of the first device 2. After this extended key exchange stage a shared encryption key K is calculated in both devices 2, 3. The first device 2 utilizes the parameter q, the second key Y2 and the first secret X1, and computes K1=(Y2)^{X1} mod q (block 204). In a corresponding manner, the second device 3 utilizes the parameter q, the first key Y1 and the second secret X2, and computes K2=(Y1)^{X2} mod q (block 205). If the data transmission has been conducted without disturbances, and outsiders have not influenced the data transmission process, it is true that K1=K2, hence both devices 2, 3 are aware of the same shared encryption key K (=K1=K2), which can be used for encryption of information to be transmitted via the first (radio) data transmission connection and for decryption after the parties have checked the authenticity of each other.

The information to be transmitted via the data transmission connection set up between the devices 2, 3 is thus encrypted in the transmitting device with the shared encryption key K or with the first key as was stated in the description of the first embodiment of the present invention, wherein the decryption can be conducted in the receiving device with a corresponding shared encryption key K or the first key, respectively.

In systems based on the Bluetooth™ technology, the aforementioned authentication of the parties is normally conducted only at a stage when two devices 2, 3 communicate with each other for the first time. Thus the delivery of the first key Y1 and possible other values such as the second key Y1 and/or a, q is only necessary at the start of the communication. The delivery according to the present invention is quite safe and user friendly thus relatively long keys can be used. This reduces the risks of short keys and eavesdropping compared to key delivery methods and systems of prior art.

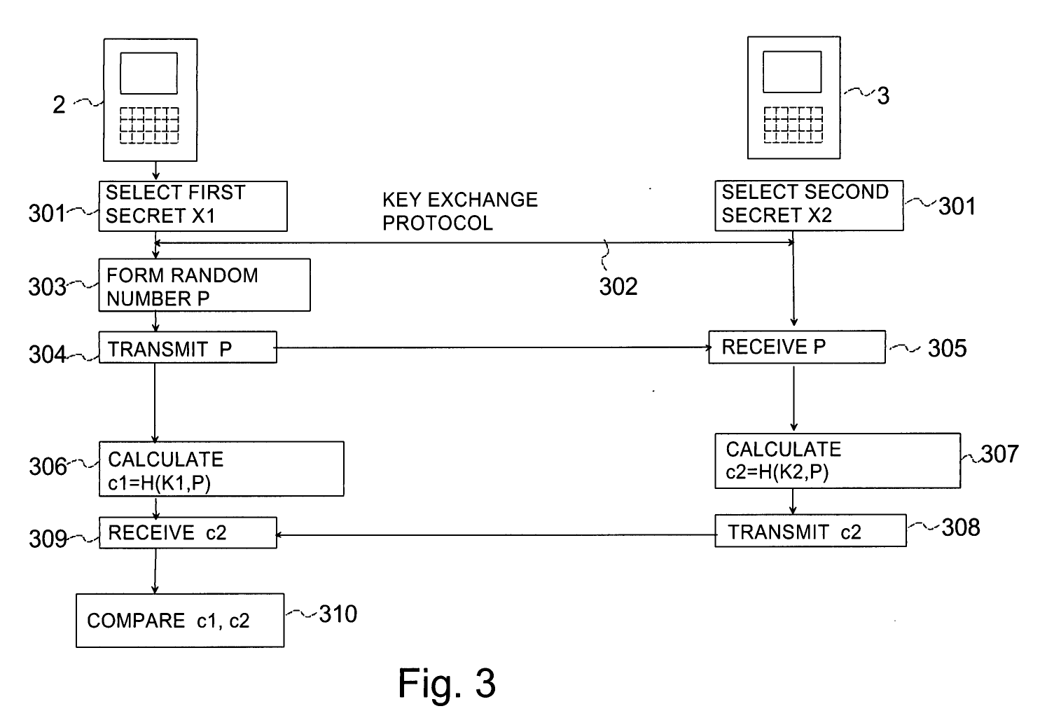

In the following, the operation of the method according to a third embodiment of the invention will be described with reference to the reduced chart shown in FIG. 3. In a situation where the aim is to set up a data transmission connection between the first 2 and the second device 3, the following steps are taken in the method according to a third embodiment of the invention. The data transmission devices 2, 3 conduct the extended key exchange stage (block 302) as presented above in the description of the second embodiment.

In this third embodiment the checking stage is conducted in the following manner. The first device 2 selects a random string P (block 303) and transmits (block 304) the selected random string P by the second communication means 11a to the second device 3. The random string P is received (block 305) by the second communication means 11b of the second device 3. Thereafter, the second device 3 calculates a second check string c2 (block 307) on the basis of the received random string P and the secret key K2 and transmits it to the first device 2 by the second communication means 11b (block 308). The first device 2 receives (block 309) the second check string c2 and calculates a first check string c1 (block 306) on the basis of the random string P selected by the first device 2 and the secret key K1, and compares (block 310) it with the second check string c2 received from the second device 3. If the check strings c1, c2 correspond to each other, the user of the first device 2 may be informed, for example with the display 7a that the check strings match. Thus, the shared encryption key K is reliable, and it can be used in the encryption of data transmission and the data transmission connection between the devices 2, 3 can be taken in use.

In a method according to yet another embodiment of the invention both devices 2, 3 perform an interactive key exchange stage to generate the same secret keys Y1, Y2 in both devices. The key exchange stage is conducted using for example the Diffie-Hellman key exchange protocol. Thus, in the first device parameters a, q are selected, a first secret X1 is generated, and a first key Y1 is calculated, for example, by means of the formula Y1=a^{X1} mod q. The first device 2 transmits the values a, q, Y1 to the second device 3 by the second communication means 11a. The second device 3 generates a second secret X2, calculates a second key by means of the formula Y2=a^{X2} mod q and transmits the second key number Y2 to the first device 2 by the second communication means 11b. After this interactive key exchange stage the first device 2 calculates a first check string c1 on the basis of the random string P it has generated and the first Y1 and the second key Y2. The first device 2 transmits the first check string c1 it has calculated to the second device 3 by the second communication means 11a. The second device 3 receives the string transmitted by the first device 2 by the second communication means 11b. Thereafter a checking stage is conducted in the second device 3. Thus, the second device 3 calculates a second check string c2 on the basis of the random string P and the first Y1 and the second key number Y2. Thereafter the second device 3 compares the received first check string c1 to the calculated second check string c2. The second device 3 indicates the result of the check for example with a signal and/or on the display 7b, for example when the check strings c1, c2 do not match. Thus, the user can notice the situation and refrain from starting the data transmission process. If the strings are identical, it can be assumed that the first Y1 and the second key number Y2 are reliable, i.e. with a strong probability the keys are the same in both devices.

It is possible that also the first device 2 performs the checking stage. In that case the second device 3 transmits the second checking string c2 to the first device 2 which then compares the first checking string c1 with the second checking string c2.

In all the above-presented embodiments, the user of the first device 2 and the user of the second device 3 can be different persons, or the same person can operate both devices 2, 3.

The method according to the invention can be applied especially in such systems in which the key exchange is conducted by means of a method based on asymmetric encryption, wherein it is possible to prevent passive eavesdropping, but an intervention by a third party is possible. For example, the present invention can be used, not only with the present Bluetooth pairing system and with an improved Bluetooth pairing system, but also with other systems in which e.g. a registration and/or key exchange is performed locally between two or more devices. The improved Bluetooth pairing proposal is disclosed by Christian Gehrmann, Kaisa Nyberg: Enhancements to Bluetooth Baseband Security; in Proceedings of Nordsec 2001, Nov. 1-2, 2001, Technical University of Denmark, Lyngby, Denmark. Furthermore, it should be possible to verify the devices 2, 3, i.e. it is mainly possible to use short-range systems in which the users can see both devices 2, 3. Thus, the invention is especially applicable in temporary short-range data transmission connections, for example in the wireless coupling of peripheral devices to a data processing device, when the user is logging in to a wireless local area network by means of a wireless data processing device, etc.

In the following some further implementation examples are given. Suppose that a mobile phone and Bluetooth headset are paired with each other. The pairing function is activated on both devices (unlike normal pairing, there is no need to select the headset device from a list on the mobile phone). The headset is placed near the microphone of the mobile phone. The headset generates an audio signal that contains the Bluetooth address of the headset and a freshly generated PIN code (or K, MAC code in the improved Bluetooth pairing proposal by Nyberg & Gehrmann).

The mobile phone records the sound, decodes the information from the sound, contacts the headset (using the Bluetooth address it received) and proves that it knows the key. Assuming that nobody else could have heard and decoded the sound, the headset now knows that the connection came from the right phone.

In another example implementation a wireless presentation software (for example a Nokia Wireless Presenter) is executed on a laptop, and a mobile phone is placed near the speaker of the laptop. The laptop outputs the audio signal according to the present invention. This audio signal is received by the microphone of the mobile phone and decoded by the audio circuitry of the mobile phone. After that the wireless presentation software is also started on the mobile phone and a secure Bluetooth connection is established after which a presentation application such as a PowerPoint™ presentation which is run on the laptop can be controlled from the phone. Obviously this could be used between two mobile phones as well.

The present invention can also be applied to other network technologies than Bluetooth™ as well, such as Wireless LANs.

The present invention also allows group communication implementations. Normally the acoustic communication between the second communication means 11a, 11b of the devices 2, 3 would use a very low volume inter alia to prevent eavesdropping, but increasing the volume can extend the radius into which the devices 2, 3 can communicate with each other by the second communication means 11a, 11b. This could be used, for example, in a meeting to set up a group of everyone in the room therein the devices in the room can communicate with each other.

Similar acoustic communication could be applied in other situations where there is a need to transfer some information to a phone. For example, acoustic tags could be used in connection with the devices. As the acoustic tag a voice playback chip (like those used in musical greeting cards) could be used to store the identification information. The acoustic tag could be quite small and cheap, and it would include the voice playback chip (one version by Winbond Electronics Corp. is 8×13×1 mm and costs a couple of dollars), a miniature speaker, a small battery and a switch that activates the playback.

In yet another example embodiment of the present invention the acoustic signal comprises the data and another signal, for example music or another kind of sound. The another signal may then be different with different devices. For example, the user may want to connect her/his wireless communication device with a headset, another wireless communication device, a computer, or another kind of device. The device which initiates the connection (i.e. the wireless communication device in this example) to the other device, selects the another signal according to the device with which the connection is to be performed. By this arrangement the user can hear different sounds when the connection is initiated to different devices. It may also be possible that the user can select the another sound for different devices, for example, by selecting different pieces of music for different devices.

1. A method for setting up a short-range wireless data transmission connection between a first and a second device, the method comprising conducting a set up stage to transmit set up information from the first device to the second device, and using said set up information in the second device to set up the connection between the first device and the second device, the set up stage comprising forming an acoustical signal including said set up information and transmitting said acoustical signal from the first device to the second device.

2. The method according to claim 1 comprising including an address of the first device in said set up information.

3. A method for ensuring data transmission security between a first and a second device in short-range wireless radio communication in which, to set up a data transmission connection, the first and the second device conduct a key exchange stage to transmit at least a first key from the first device to the second device, and using said key to derive an encryption key to encrypt data to be transmitted between the first device and the second device, the method comprising forming an acoustical signal comprising information on said first key and transmitting said acoustical signal from the first device to the second device.

4. The method according to claim 3 comprising determining a first secret in the first device, determining a second secret in the second device, calculating said first key in the first device on the basis of said first secret, calculating a second key in the second device on the basis of said second secret, transmitting said first key to the second device, transmitting said second key to the first device, calculating a first encryption key in the first device on the basis of said first secret and said second key, calculating a second encryption key in the second device on the basis of said second secret and said first key, encrypting data to be transmitted from the first device to the second device by using said first encryption key, and encrypting data to be transmitted from the second device to the first device by using said second encryption key.

5. The method according to claim 4 comprising decrypting information received from the first device in the second device by using said second key, and decrypting information received from the second device in the first device by using said first key.

6. The method according to claim 3, said key exchange stage comprising:
in the first device selecting a first parameter, generating a first secret, calculating a first key on the basis of said first parameter and said first secret, and transmitting said first key to the second device; and
in the second device selecting a second parameter, generating a second secret, calculating a second key on the basis of said second parameter and said second secret, and transmitting said second key to the first device.

7. The method according to claim 6 comprising
in the first device calculating a shared encryption key using said first parameter, said second key and said first secret;
in the second device calculating a shared encryption key using said second parameter, said first key and said second secret; and
using said shared encryption key for encrypting data to be transmitted between the first and the second device.

8. The method according to claim 6 comprising in the first device
selecting a random character string;
calculating a first check string on the basis of said random character string and said first key; and
transmitting said random character string to the second device;
in the second device
receiving said random character string;
calculating a second check string on the basis of said random character string and said second key; and
transmitting said second check string to the first device;
the method further comprising comparing said first check string and said second check string, wherein if the comparison indicates that said first and said second check strings are identical, data to be transmitted from the first device to the second device is encrypted by said first key, and data to be transmitted from the second device to the first device is encrypted by said second key.

9. A communication system comprising at least a first and a second device, and means for setting up a short-range wireless radio communication between said first and second device;
the first device comprising at least an acoustical transmitter for transmitting acoustical signals comprising set up information from the first device to the second device; and
the second device comprising at least:
an acoustical receiver for receiving acoustical signals comprising said set up information from the first device; and
means for using said set up information in the second device to set up the connection between the first device and the second device.

10. The communication system according to claim 9 comprising an address defined for said first device, wherein said address of the first device is included with said set up information.

11. A communication system comprising at least a first and a second device, means for setting up a short-range wireless radio communication between said first and second device, and means for ensuring data transmission security in the data transmission connection, comprising means for conducting a key exchange stage to transmit at least a first key from the first device to the second device, and means for deriving at least one encryption key on the basis of said first key in the first and second device, the system further comprising acoustical transmission means for transmitting acoustical signals comprising information on said first key from the first device to the second device, means for deriving an encryption key on the basis of said first key, and encrypting means for encrypting data to be transmitted between the first device and the second device by using said encryption key.

12. The communication system according to claim 11, the first device comprising:
means for determining a first secret;
means for calculating a first key on the basis of said first secret; and
an acoustical transmitter for transmitting said first key to the second device; and
the second device comprising:
an acoustical receiver for receiving said first key;
means for determining a second secret;
means for calculating a second key on the basis of said second secret;
means for calculating a second encryption key in the second device on the basis of said second secret and said first key;
an acoustical transmitter for transmitting said second key to the first device; and
means for encrypting data to be transmitted from the second device to the first device by using said second encryption key;
wherein the first device further comprises:
an acoustical receiver for receiving said second key;
means for calculating a first encryption key on the basis of said first secret and said second key; and
means for encrypting data to be transmitted from the first device to the second device by using said first encryption key.

13. The communication system according to claim 12, the first device comprising decrypting means for decrypting information received from the second device by using said first key; and the second device comprising decrypting means for decrypting information received from the first device by using said second key.

14. The communication system according to claim 11, said means for conducting a key exchange stage comprising:
in the first device means for selecting a first parameter, generating a first secret, calculating a first key on the basis of said first parameter and said first secret, and transmitting said first key to the second device; and
in the second device means for selecting a second parameter, generating a second secret, calculating a second key on the basis of said second parameter and said second secret, and transmitting said second key to the first device.

15. The communication system according to claim 14 comprising
in the first device means for calculating a shared encryption key using said first parameter, said second key and said first secret; and
in the second device means for calculating a shared encryption key using said second parameter, said first key and said second secret; and
encrypting means for encrypting data to be transmitted between the first and the second device using said shared encryption key.

16. The communication system according to claim 14 comprising in the first device means for
selecting a random character string;
calculating a first check string on the basis of said random character string and said first key; and
transmitting said random character string to the second device; and
in the second device means for
receiving said random character string;
calculating a second check string on the basis of said random character string and said second key; and
transmitting said second check string to the first device;
the communication system further comprising a comparator for comparing said first check string and said second check string, wherein if the comparison indicates that said first and said second check strings are identical, data to be transmitted from the first device to the second device is encrypted by said first key, and data to be transmitted from the second device to the first device is encrypted by said second key.

17. A device comprising at least short-range wireless radio communication means for performing short-range data transmission with another device, and an acoustical transmitter for transmitting acoustical signals comprising set up information from the first device to the another device.

18. The device according to claim 17 comprising an address, wherein said address of the device is included with said set up information.

19. A device comprising at least short-range wireless radio communication means for performing short-range data transmission, and means for ensuring data transmission security in the data transmission, comprising means for conducting a key exchange stage to transmit at least a first key from the device to another device, and means for deriving at least one encryption key on the basis of said first key, the device further comprising a acoustical transmission means for transmitting acoustical signals comprising information on said first key from the device to said another device, means for deriving an encryption key on the basis of said first key, and encrypting means for encrypting data to be transmitted to said another device by using said encryption key.

20. The device according to claim 19, the device comprising:
means for determining a first secret;
means for calculating a first key on the basis of said first secret;
an acoustical transmitter for transmitting said first key to said another device;
a receiver for receiving a second key calculated in said another device on the basis of a second secret;
means for calculating a first encryption key on the basis of said first secret and said second key; and
means for encrypting data to be transmitted from the device to said another device by using said first encryption key.

21. The device according to claim 20 comprising decrypting means for decrypting information received from said another device by using said first key.

22. The device according to claim 19, said means for conducting a key exchange stage comprising:
means for selecting a first parameter, generating a first secret, calculating a first key on the basis of said first parameter and said first secret, and transmitting said first key to the another device; and
means for receiving a second key calculated in said another device.

23. The device according to claim 22 comprising
means for calculating a shared encryption key using said first parameter, said second key and said first secret; and
encrypting means for encrypting data to be transmitted to said another device using said shared encryption key.

24. The device according to claim 22 comprising:
means for selecting a random character string;
means for calculating a first check string on the basis of said random character string and said first key;
means for transmitting said random character string to the another device;
a receiver for receiving a second check calculated in said another device; and
a comparator for comparing said first check string and said second check string,
wherein if the comparison indicates that said first and said second check strings are identical, data to be transmitted from the device to the another device is encrypted by said first key, and data to be transmitted from the another device to the device is encrypted by said second key.

25. The device according to claim 22, said acoustical transmission means being adapted to include another acoustical signal with said acoustical signal comprising information on said first key.

26. The device according to claim 25, wherein said another acoustical signal is selected according to the type of the another device.

27. The device according to claim 19, wherein it is a wireless communication device.

28. The device according to claim 19, wherein it is a computer.

29. The device according to claim 19, wherein it is a headset.

30. The device according to claim 19, wherein it is a PDA device.

31. The device according to claim 19, wherein it is a printer.

32. A module to be used in connection with a device comprising at least short-range wireless radio communication means for performing short-range data transmission with another device, the module comprising an acoustical transmitter for transmitting acoustical signals comprising set up information from the first device to the another device.

33. The module according to claim 32 comprising means for determining an address of the first device, wherein said address of the device is included with said set up information.

34. A module to be used in connection with a device comprising at least a short-range wireless radio communication means for performing short-range data transmission, and means for ensuring data transmission security in the data transmission, the module comprising means for conducting a key exchange stage to transmit at least a first key from the device to another device, and means for deriving at least one encryption key on the basis of said first key, the module further comprising an acoustical transmission means for transmitting acoustical signals comprising information on said first key from the device to said another device, means for deriving an encryption key on the basis of said first key, and means for informing said encryption key to said device for encrypting data to be transmitted to said another device by using said encryption key.

35. A computer program product comprising machine executable steps stored in a memory for setting up a short-range wireless data transmission connection between a first and a second device when executed by a processing means, the steps for conducting a set up stage to transmit set up information from the first device to the second device, and steps for using said set up information in the second device to set up the connection between the first device and the second device, the set up stage comprising machine executable steps for forming an acoustical signal including said set up information and transmitting said acoustical signal from the first device to the second device.

36. The computer program product according to claim 35 comprising machine executable steps for including an address of the first device in said set up information.

37. A computer program product comprising machine executable steps stored in a memory for ensuring data transmission security between a first and a second device in short-range wireless radio communication when executed by a processing means in which, to set up a data transmission connection, steps are executed for conducting a key exchange stage between the first and the second device to transmit at least a first key from the first device to the second device, and using said key to derive an encryption key to encrypt data to be transmitted between the first device and the second device, the computer program product comprising machine executable steps for forming an acoustical signal comprising information on said first key and transmitting said acoustical signal from the first device to the second device.
